(19) United States
(12) Patent Application Publication
(10) Pub. No.: US 2017/0357461 A1
(43) Pub. Date: Dec. 14, 2017

(54) DATA STORAGE DEVICE AND OPERATING METHOD THEREOF

(71) Applicant: SK hynix Inc., Gyeonggi-do (KR)

(72) Inventor: Gi Pyo UM, Gyeonggi-do (KR)

(21) Appl. No.: 15/249,135

(22) Filed: Aug. 26, 2016

(30) Foreign Application Priority Data
Jun. 9, 2016 (KR) 10-2016-0071761

(51) Int. Cl. G06F 3/06; G06F 9/44; G06F 1/24

(52) U.S. Cl. CPC G06F 3/0625; G06F 1/24; G06F 9/4401; G06F 3/0655; G06F 3/0679

(57) ABSTRACT

A data storage device includes a nonvolatile memory device; and a controller suitable for controlling the nonvolatile memory device. The controller includes a status storage unit suitable for storing a status information on the nonvolatile memory device; and a reset unit suitable for selectively performing a reset operation for the nonvolatile memory device, based on the status information, when performing a booting operation.

### CROSS-REFERENCES TO RELATED APPLICATION

The present application claims priority under 35 U.S.C. §119(a) to Korean application number 10-2016-0071761, filed on Jun. 9, 2016, in the Korean Intellectual Property Office, which is incorporated herein by reference in its entirety.

### BACKGROUND

### 1. Technical Field

Various embodiments generally relate to a data storage device, and, more particularly, to a data storage device including a semiconductor memory device and an operating method thereof.

### 2. Related Art

Data storage devices having one or more semiconductor memory devices (simply referred hereinafter as data storage devices or memory systems) are widely employed for storing data provided by an external device in response to a write request. Data storage devices may also provide stored data to an external device in response to a read request. Examples of external devices exchanging data with data storage devices include computers, digital cameras, cellular phones and the like. Data storage devices may be embedded in an external device during manufacturing of the external devices or may be fabricated separately and then connected afterwards to an external device.

### SUMMARY

Various embodiments of the present invention are directed to an improved data storage device capable of more quickly completing a booting operation with a lower power consumption, and an operating method thereof.

In an embodiment, a data storage device may include: a nonvolatile memory device; and a controller suitable for controlling the nonvolatile memory device, the controller including: a status storage unit suitable for storing a status information on the nonvolatile memory device; and a reset unit suitable for selectively performing a reset operation for the nonvolatile memory device, based on the status information, when performing a booting operation.

In an embodiment, a method for operating a data storage device may include: starting a booting operation; checking a status information on a nonvolatile memory device stored in a status storage unit; and selectively performing a reset operation for the nonvolatile memory device, based on the status information.

In an embodiment, a data storage device may include: a nonvolatile memory device; and a controller suitable for controlling the nonvolatile memory device, the controller including: a status storage unit suitable for storing a status information on the nonvolatile memory device; and a reset unit suitable for checking the status information to skip a reset operation for the nonvolatile memory device when performing a warm booting operation; an interface setting unit: suitable for checking the status information to skip an interface setting operation for the nonvolatile memory device when performing the warm booting operation.

### BRIEF DESCRIPTION OF THE DRAWINGS

The above and other features and advantages of the present invention will become more apparent to those skilled in the art to which the present invention belongs by describing in detail various embodiments thereof with reference to the attached drawings in which:

FIG. 1 is a block diagram illustrating an example of a data storage device, according to an embodiment of the present invention.

FIG. 2 is a flow chart describing a method of operating a data storage device, according to an embodiment of the present invention.

FIG. 3 is a block diagram illustrating an example of a solid state drive (SSD), according to an embodiment of the present invention.

FIG. 4 is a block diagram illustrating an example of a data processing system, according to an embodiment of the present invention.

### DETAILED DESCRIPTION

Hereinafter, a data storage device and an operating method thereof according to the present invention will be described with reference to the accompanying drawings through exemplary embodiments of the present invention. The present invention may, however, be embodied in different forms and should not be construed as being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings, that the drawings are not necessarily to scale, and, in some instances, proportions may have been exaggerated in order to more clearly depict certain features of the invention. While particular terminology is used, it is to be appreciated that the terminology used is for describing particular embodiments only and is not intended to limit the scope of the present invention.

It is further noted that in the described embodiments, many details are set forth for providing a thorough understanding of the present invention. However, as it will be understood by those skilled in the art to which the present invention pertains the present invention may be practiced without some or all of these specific details. In other instances, well-known structures and/or processes have not been described in detail in order not to unnecessarily obscure the disclosure of the present invention.

It is also noted, that in some instances, as would be apparent to those skilled in the relevant art, an element (also referred to as a feature) described in connection with one embodiment may be used singly or in combination with other elements of another embodiment, unless specifically indicated otherwise.

Hereinafter, the various embodiments of the present invention will be described in detail with reference to the attached drawings.

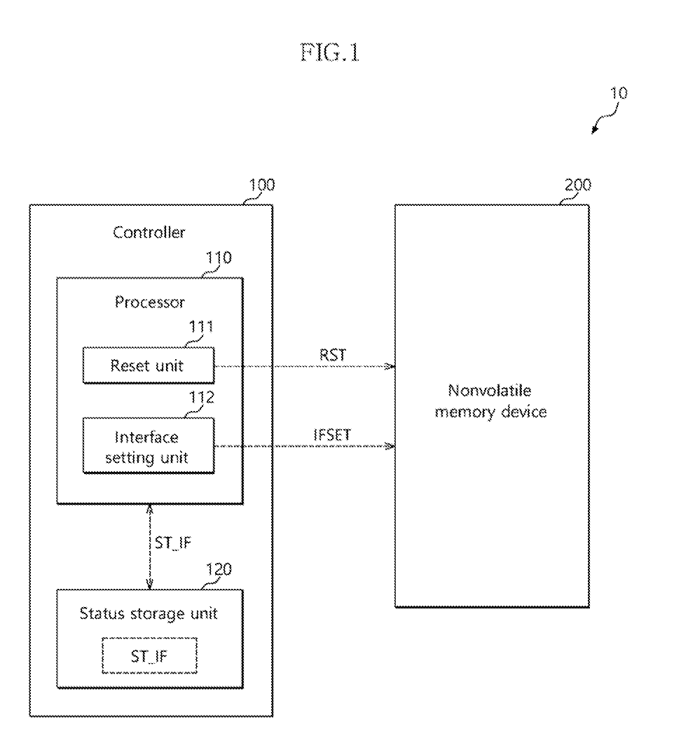

FIG. 1 is a block diagram illustrating an example of a data storage device 10, according to an embodiment of the present invention.

Referring to FIG. 1, the data storage device 10 may be configured to store data provided from an external device (not shown), in response to a write request from the external device. Also, the data storage device 10 may be configured to provide stored data to the external device, in response to a read request from the external device.

The data storage device 10 may be implemented in the form of a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), a Solid State Drive (SSD) and the like.

The data storage device 10 may include a controller 100 and a nonvolatile memory device 200.

The controller 100 may include a processor 110 and a status storage unit 120.

The processor 110 may control the operations of the data storage device 10 including to but not limited to read, write, erase, and various background operations such as garbage collection, bad block management, memory wear leveling and the like. The processor 110 may control the operation of the internal units of the controller 100, for example, the processor 110 may control the operation of an error correction unit for detecting and correcting data errors. The processor 110 may control the operation of the nonvolatile memory device 200, for example, for storing data to the nonvolatile memory device in response to a write request or a for reading data from the nonvolatile memory device and transferring the data to an external device in response to a read request from the external device.

The processor 110 may perform a booting operation. The booting operation may be followed by a reset operation RST and an interface setting operation IFSET. For example, the processor 110 may perform a cold booting operation when it is powered on after it is powered off. Also, the processor 110 may perform the booting operation in response to a request from an external device. The booting operation may include a warm booting operation for resetting the internal units of the controller 100 while power supply is retained.

The processor 110 may include a reset unit 111 and an interface setting unit 112,

The reset unit 111 may perform a reset operation for the internal units of the controller 100 when the booting operation is performed. The reset unit 111 may selectively perform the reset operation RST for the nonvolatile memory device 200, based on a status information ST_IF on the nonvolatile memory device 200 stored in the status storage unit 120, when the booting operation is performed. For example, the reset unit 111 may check the status information ST_IF on the nonvolatile memory device 200 stored in the status storage unit 120, and perform the reset operation RST for the nonvolatile memory device 200 in the case where the status information ST_IF is not recognized from the status storage unit 120 due to erasure. After performing the reset operation RST for the nonvolatile memory device 200, the reset unit 111 may update a reset history of the nonvolatile memory device 200 in the status information ST_IF. The reset unit 111 may skip the reset operation RST for the nonvolatile memory device 200, when the reset history of the nonvolatile memory device 200 is recognized based on the status information ST_IF.

The interface setting unit 112 may perform the interface setting operation. IFSET for the nonvolatile memory device 200. The interface setting unit 112 may perform the interface setting operation IFSET, for example, to change an interface mode of the nonvolatile memory device 200 from a single data rate (SDR) mode to a double data rate (DDR) mode or vice versa.

The interface setting unit 112 may selectively perform the interface setting operation IFSET for the nonvolatile memory device 200, based on the status information ST_IF, when the booting operation is performed. For example, the interface setting unit 112 may check the status information ST_IF on the nonvolatile memory device 200 stored in the status storage unit 120, and perform the interface setting operation IFSET for the nonvolatile memory device 200 in the case where the status information ST_IF is not recognized from the status storage unit 120 due to erasure. After performing the interface setting operation IFSET, the interface setting unit 112 may update an interface, setting history of the nonvolatile memory device 200 in the status information ST_IF. The interface setting unit 112 may skip the interface setting operation IFSET for the nonvolatile memory device 200, when the interface setting history of the nonvolatile memory device 200 is recognized based on the status information ST_IF.

The status storage unit 120 may include the status information ST_IF on the nonvolatile memory device 200. The status information ST_IF may include the reset history and interface setting history of the nonvolatile memory device 200. The status information ST_IF may be updated each time at least one of the reset operation RST and the interface setting operation IFSET is performed on the nonvolatile memory device 200. Hence, the status information ST_IF may reflect the latest status of the nonvolatile memory device 200.

The status storage unit 120 may be constructed by a volatile memory device. A volatile memory device does not retain data stored therein when power is cut off. In an embodiment, the status storage unit 120 may be or include a Static Random Access Memory (SRAM). In another embodiment, the status storage unit 120 may be or include a Dynamic Random Access Memory (DRAM).

Therefore, when a cold booting operation is performed, the status information ST_IF of the status storage unit 120 may be erased. On the contrary, when a warm booting operation is performed both the status of the nonvolatile memory device 200 and the status information ST_IF of the status storage unit 120 may be retained. Accordingly, when a warm booting operation is performed, the reset unit 111 may check the status information ST_IF to skip the reset operation RST for the nonvolatile memory device 200. Further, when the warm booting operation is performed, similarly to the reset unit 111, the interface setting unit 112 may check the status information ST_IF to skip the interface setting operation IFSET for the nonvolatile memory device 200. Thus, since the redundant reset and the interface setting operations RST and IFSET are skipped, the booting operation may be quickly completed and power consumption may be reduced.

The nonvolatile memory device 200 may store data transmitted from the controller 100 and may read stored data and transmit read data to the controller 100, according to control of the controller 100. The nonvolatile memory device 200 may be reset by the reset operation RST of the reset unit 111. Moreover, the nonvolatile memory device 200 may be set to an interface mode for the controller 100, by the interface setting operation IFSET of the interface setting unit 112.

The nonvolatile memory device 200 may be or include a flash memory, such as NAND flash or NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

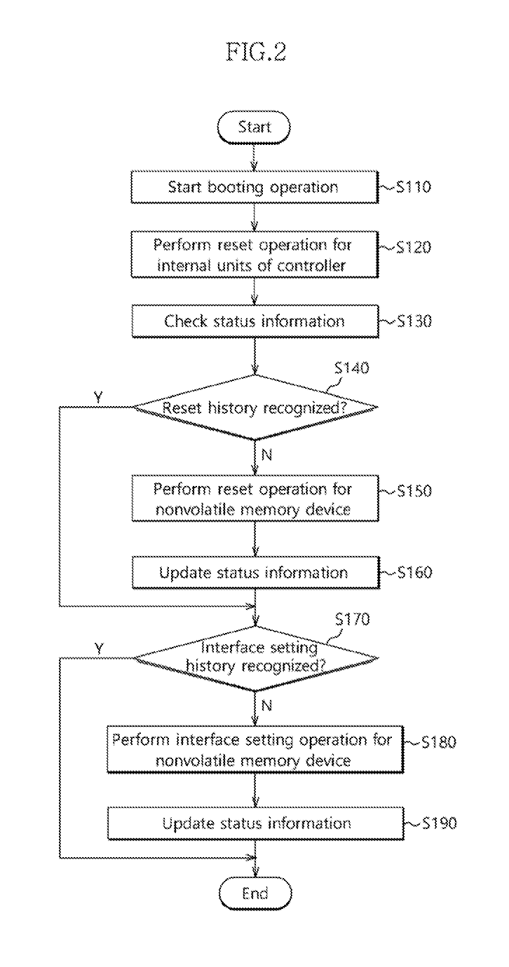

FIG. 2 is a flow chart describing a method of operating a data storage device, according to an embodiment of the present invention.

Hereinbelow a method of operating the data storage device 10 of FIG. 1 for performing a booting operation will be described in detail with reference to FIGS. 1 and 2.

Referring to FIG. 2, at step S110, the processor 110 may start a booting operation. For example, the processor 110 may start a cold booting operation when it is powered on after it is powered off or a warm booting operation in response to a request from the external device.

At step S120, the reset unit 111 may perform a reset operation for the internal units of the controller 100.

At step S130, the reset unit 111 may check the status information ST_IF on the nonvolatile memory device 200 stored in the status storage unit 120. In case of the cold booting operation, the status information ST_IF will not be recognized due to erasure by the power-off. On the contrary, in case of the warm booting operation, the status information ST_IF will be retained and recognized.

At step S140, the reset unit 11 may determine, based on the status information ST_IF, whether a reset history is recognized, When the reset history is recognized in case of the warm booting operation, the process may proceed to step S170. That is to say, the redundant reset operation RST for the nonvolatile memory device 200 may be skipped. When the reset history is not recognized in case of the cold booting operation, the process may proceed to step S150.

At step S150 the reset unit 111 may perform the reset operation RST for the nonvolatile memory device 200.

At step S160, the, reset unit 111 may update the status information ST_IF of the status storage unit 120. The updated status information ST_IF may include the reset history of the nonvolatile memory device 200

At step S170, the interface setting unit 112 may determine, based on the status information ST_IF, whether an interface setting history is recognized. When the interface setting history is recognized in case of the warm booting operation, the process may be ended. That is to say, the redundant interface setting operation IFSET for the nonvolatile memory device 200 is skipped. When the interface setting history is not recognized in case of the cold booting operation, the process may proceed to step S180.

At step S180, the interface setting unit 112 may perform the interface setting operation IFSET for the nonvolatile memory device 200.

At step S190, the interface setting unit 112 may update the status information. ST_IF of the status storage unit 120. The updated status information ST_IF may include the interface setting history of the nonvolatile memory device 200

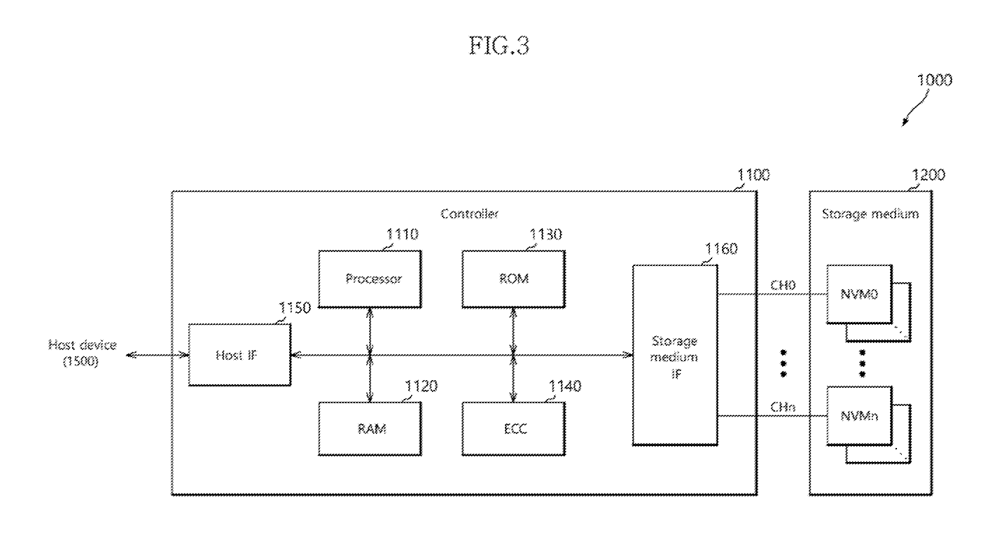

FIG. 3 is a block diagram illustrating an example of a solid state drive (SSD) 1000, according to an embodiment of the is present invention.

Referring to FIG. 3, the SSD 1000 may include a controller 1100 and a storage medium 1200.

The controller 1100 may control data exchange between a host device 1500 and the storage medium 1200. The controller 1100 may include a processor 1110, a Random Access Memory (RAM) 1120, a Read Only Memory (ROM) 1130, an Error Correction Code (ECC) unit 1140, a host interface 1150, and a storage medium interface 1160.

The processor 1110 may control the operations of the controller 1100. For example the processor 1110 may store data in the storage medium 1200 and read stored data from the storage medium 1200, according to data processing requests from the host device 1500. In order to efficiently manage the storage medium 1200, the processor 1110 may control internal operations of the SSD 1000 such as a merge operation, a wear leveling operation, and so forth.

Also, the processor 1110 may operate in a manner substantially similar to the processor 110 shown in FIG. 1. The processor 1110 may selectively perform a reset operation for the storage medium 1200, based on a status information of the storage medium 1200. Also, the processor 1110 may selectively perform an interface setting operation for the storage medium 1200, based on the status information of the storage medium 1200.

The RAM 1120 may store programs and program data to be used by the processor 1110. The RAM 1120 may temporarily store data transmitted from the host interface 1150 before transferring it to the storage medium 1200, and may temporarily store data transmitted from the storage medium 1200 before transferring it to the host device 1500.

The ROM 1130 may store program codes to be read from the processor 1110. The program codes may include commands to be processed by the processor 1110, such that the processor 1110 may control the internal units of the controller 1100.

The ECC unit 1140 may encode data to be stored in the storage medium 1200, and may decode data read from the storage medium 1200. The ECC unit 1140 may detect and correct an error occurred in data, according to an ECC algorithm.

The host interface 1150 may exchange data processing requests, data, etc. with the host device 1500.

The storage medium interface 1160 may transmit control signals and data to the storage medium 1200. The storage medium interface 1160 may receive data from the storage medium 1200. The storage medium interface 1160 may be coupled to the storage medium 1200 through a plurality of channels CHO to CHn.

The storage medium 1200 may include a plurality of nonvolatile memory devices NVMO to NVMn. Each of the plurality of nonvolatile memory devices NVMO to NVMn may perform an operation, for example, a write, read and erase operations according to control of the controller 1100.

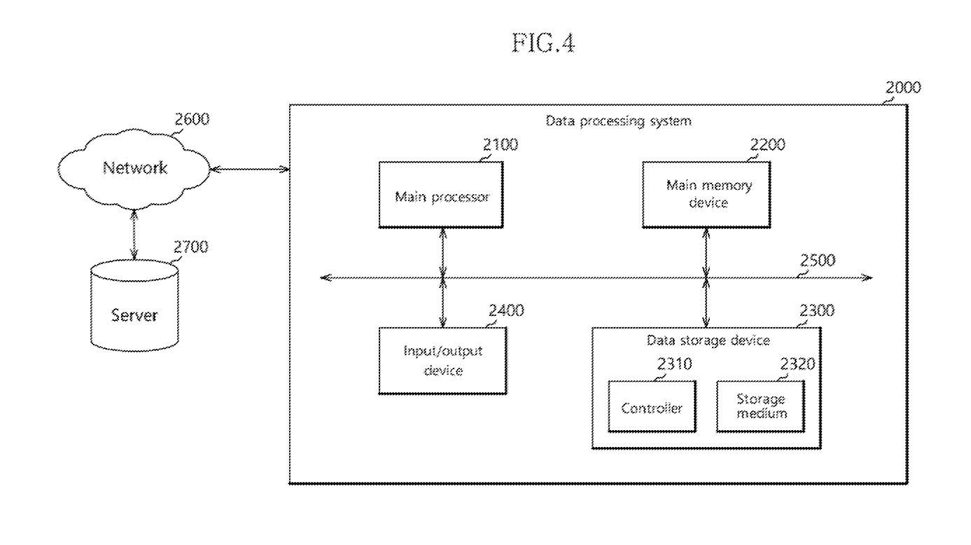

FIG. 4 is a block diagram illustrating an example of a data processing system 2000, according to an embodiment of the present invention.

Referring to FIG. 4, the data processing system 2000 may be or include a computer, a laptop, a netbook, a smart phone a digital TV, a digital camera, a navigator, and the like. The data processing system 2000 may include a main processor 2100, a main memory device 2200, a data storage device 2300, and an input/output device 2400. The internal units of the data processing system 2000 may exchange data, control signals, etc. through a system bus 2500.

The main processor 2100 may control operations of the data processing system 2000. The main processor 2100 may be a central processing unit, for example, such as a microprocessor. The main processor 2100 may execute softwares such as an operating system, an application, a device driver, and so forth, on the main memory device 2200.

The main memory device 2200 may store programs and program data to be used by the main processor 2100. The main memory device 2200 may temporarily store data to be transmitted to the data storage device 2300 and the input/output device 2400.

The data storage device 2300 may include a controller 2310 and a storage medium 2320. The data storage device 2300 may be configured and operate in a manner substantially similar to the data storage device 10 shown in FIG. 1.

The input/output device 2400 may include a keyboard, a scanner, a touch screen, a screen monitor, a printer, a mouse, or the like, capable of exchanging data with a user, such as receiving a command for controlling the data processing system 2000 from the user or providing a processed result to the user.

According to an embodiment, the data processing system 2000 may communicate with at least one server 2700 through a network 2600 such as a local area network (LAN), a wide area network (WAN), a wireless network, and so on. The data processing system 2000 may include a network interface (not shown) to access the network 2600.

While various embodiments have been described above, it will be understood to those skilled in the art that the embodiments described are examples only. Accordingly, the data storage device and the operating method thereof described herein should not be limited based on the described embodiments.

What is claimed is:

1. A data storage device comprising:
a nonvolatile memory device; and
a controller suitable for controlling the nonvolatile memory device,
the controller comprising:
a status storage unit suitable for storing a status information on the nonvolatile memory device; and
a reset unit suitable for selectively performing a reset operation for the nonvolatile memory device, based on the status information, when performing a booting operation.

2. The data storage device according to claim 1, wherein the reset unit performs the reset operation for the nonvolatile memory device, when the status information is not recognized from the status storage unit.

3. The data storage device according to claim 2, wherein the reset unit updates the status information after performing the reset operation.

4. The data storage device according to claim 1, wherein the reset unit skips the reset operation for the nonvolatile memory device when a reset history of the nonvolatile memory device is recognized based on the status information.

5. The data storage device according to claim 1, further comprising:
an interface setting unit suitable for selectively performing an interface setting operation for the nonvolatile memory device, based on the status information, when performing the booting operation.

6. The data storage device according to claim 5, wherein the interface setting unit performs the interface setting operation for the nonvolatile memory device, when the status information is not recognized from the status storage unit.

7. The data storage device according to claim 6, wherein the interface setting unit updates the status information after performing the interface setting operation.

8. The data storage device according to claim 5, wherein the interface setting unit skips the interface setting operation when an interface setting history of the nonvolatile memory device is recognized based on the status information.

9. The data storage device according to claim 1, wherein the status storage unit comprises a volatile memory.

10. The data storage device according to claim 1, wherein the status information is retained when a warm booting operation is performed, and is erased when a cold booting operation is performed.

11. A method for operating a data storage device, the method comprising:
starting a booting operation;
checking a status information on a nonvolatile memory device, stored in a status storage unit; and
selectively performing a reset operation for the nonvolatile memory device, based on the status information.

12. The method according to claim 11, wherein the performing of the reset operation comprises:
performing the reset operation for the nonvolatile memory device, when the status information is not recognized from the status storage unit.

13. The method according to claim 12, further comprising:
updating the status information after performing the reset operation.

14. The method according to claim 11, wherein the performing of the reset operation comprises:
skipping the reset operation for the nonvolatile memory device when a reset history of the nonvolatile memory device is recognized based on the status information.

15. The method according to claim 11, further comprising:
selectively performing an interface setting operation for the nonvolatile memory device, based on the status information.

16. The method according to claim 15, wherein the performing of the interface setting operation comprises:
performing the interface setting operation for the nonvolatile memory device, when the status information is not recognized from the status storage unit.

17. The method according to claim 16, further comprising:
updating the status information after performing the interface setting operation.

18. The method according to claim 15, wherein the performing of the interface setting operation comprises:
skipping the interface setting operation when an interface setting history of the nonvolatile memory device is recognized based on the status information.

19. The method according to claim 11, wherein the status information is retained when a warm booting operation is performed, and is erased when a cold booting operation is performed.

20. A data storage device comprising:
a nonvolatile memory device; and
a controller suitable for controlling the nonvolatile memory device,
the controller comprising:
a status storage unit suitable for storing a status information on the nonvolatile memory device; and
a reset unit suitable for checking the status information to skip a reset operation for the nonvolatile memory device when performing a warm booting operation;
an interface setting unit suitable for checking the status information to skip an interface setting operation for the nonvolatile memory device when performing the warm booting operation.
